(19) United States
(12) Patent Application Publication
(10) Pub. No.: US 2004/0221470 A1
(43) Pub. Date: Nov. 11, 2004

(54) Tape rule having laser indicating mechanism

(75) Inventor: Henry Lin, Taipei (TW)

Correspondence Address: BRUCE H. TROXELL, SUITE 1404, 5205 LEESBURG PIKE, FALLS CHURCH, VA, 22041, US

(73) Assignee: Index Measuring Tape Co., Ltd.

(21) Appl. No.: 10/434,236

(22) Filed: May 9, 2003

(51) Int. Cl. G01B 3/10

(52) U.S. Cl. 33/760

(57) ABSTRACT

Disclosed herein is a tape rule laving a laser indicating mechanism for indicating objects of different locations, and two horizon indicators for indicating whether the surface of an object is on the horizontal plane both in x-direction or y-direction.

### BACKGROUND OF THE INVENTION

1. Field of the Invention

The present invention relates to a tape rule, and more particularly, to a tape rule having a laser indicating mechanism for indicating objects of different locations and two horizon indicators for indicating the surface of an object is on the horizontal plane.

2. Description of the Prior Art

Most of conventional tape rules are generally equipped with springs in housings for winding back measuring tapes. For such a tape rule, as shown in FIG. 1, only a looking switch 101 above the housing 100 is provided. When the suspending rule is used in measurement, ill order to prevent the trouble induced from the locking of the locking switch 101, generally, the user is necessary to resist against the lower surface of the rule 200 so as to suspend the rule 200.

Since the conventional tape rules are used only for measuring the lengths of objects or distances between two objects. It is not convenient to people, especially the workmen, such as carpenters, masons, construction workers, and etc.

There are a lot of patents having disclosed a lot of multi-function tools as follows:

1. U.S. Pat. No. 4,428,515 issued to Mayer discloses a knife blade sharpener that is integrally mounted onto the scab board of a knife.

2. U.S. Pat. No. 4,783,867 issued to Tsao discloses a multifunction tool, which includes a retractable measuring tape, a pencil sharpener, a blade and other stationery tool elements that are frequently used for office work purposes.

3. U.S. Pat. No. 752,339 issued to Gutsteini discloses a pair of shears having a pencil sharpener attached thereto.

4. U.S. Pat. No. 3,809,137 issued to Dombrowski discloses a tape measurer having an integral pencil sharpener. It does not disclose a blade sharpener.

5. U.S. Pat. No. 5,040,256 issued to Mills discloses a combination of taper measurer, pencil sharpener and knife blade sharpener.

However, the above-mentioned former U.S. patents having the following disadvantages:

1. No patent discloses tape rule with functions of measuring the lengths of objects, including objects of different locations and indicating the surface of an object that is on the horizontal plane. And, these functions are very important to the carpenters, construction workers, etc.

2. Most of the above-mentioned U.S. patents provide for no other functions, besides holding a knife, a pencil sharpener, a blade sharpener, a blade sharpener, etc. However, it is very dangerous for a workman to bring a lot of tools having relations with blades when he is working.

### SUMMARY OF THE INVENTION

Accordingly, it is an object of the present invention to provide a tape rule having a laser indicating mechanism for indicating objects of different locations and horizon indicators for indicating the surface of an object is on the horizontal plane, so that the user himself/herself may obtain a very large scale of convenience.

It is another object of the present invention to provide a combination of tape rule, laser indicating mechanism, and horizon indicators, which not only can indicate an object at a location, but also another object at a different location without moving the whole tape rule. Then more convenience is provided to people.

It is another object of the present invention to provide a combination of tape rule, laser indicating mechanism and horizon indicators, which do not contain tools that may cause dangers to workmen.

A more complete understanding of these and other features and advantages of the patent invention will become apparent from a careful consideration of the following detailed description of certain embodiments illustrated in the accompanying drawings.

### BRIEF DESCRIPTION OF THE DRAWINGS

FIG. 1 is a perspective view showing an example of conventional tape rule;

FIG. 2 is a perspective view of the tape rule according to the present invention;

FIG. 3 is a perspective view of the tape rule according to the present invention seen from another direction;

FIG. 4 is an exploded perspective view according to the present invention showing the individual components;

FIG. 5 is a cross sectional view of the present invention;

FIG. 6 and FIG. 7 are the plane views showing the present invention in uses.

### DETAILED DESCRIPTION OF THE PREFERRED EMBODIMENTS

Hereinafter, the best mode for carrying out the present invention will be described more fully below with reference to attached drawings.

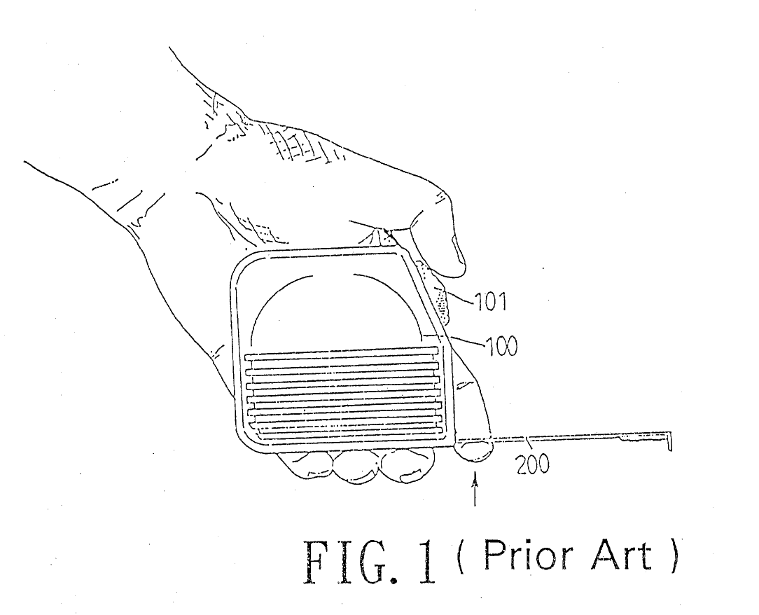

An example of conventional tape rule is shown in FIG. 1. Its function and disadvantages are described above and disadvantages are described above and would not be repeated herewith.

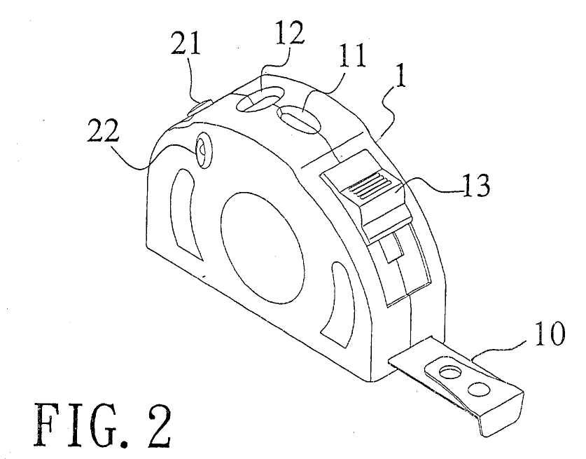

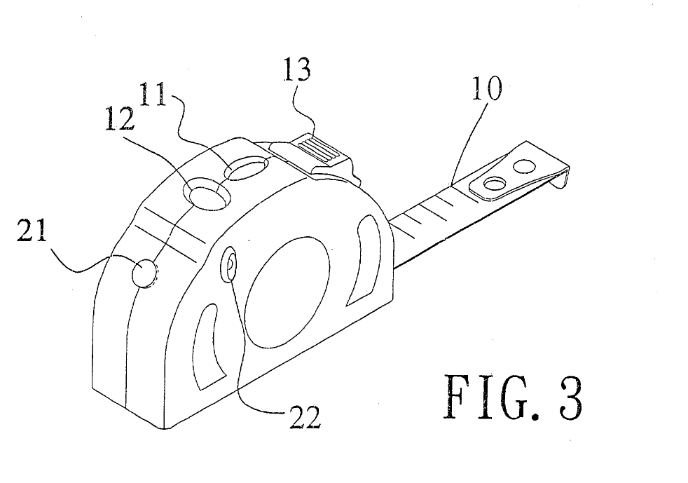

The present invention of a tape rule having laser indicating mechanism of the present invention is shown in perspective in FIG. 1 and FIG. 2. It comprises a housing 1 and a retractable measuring tape 10 to be held inside the housing. On the housing 1, there are a push button 13 for stopping and releasing the measuring tape 10, a first horizon indicator 11 and a second horizon indicator 12 for determining a horizontal plane; and a laser releasing bulb 22 together with its switching button 21 and laser generating circuit for indicating an object by releasing a beam of laser.

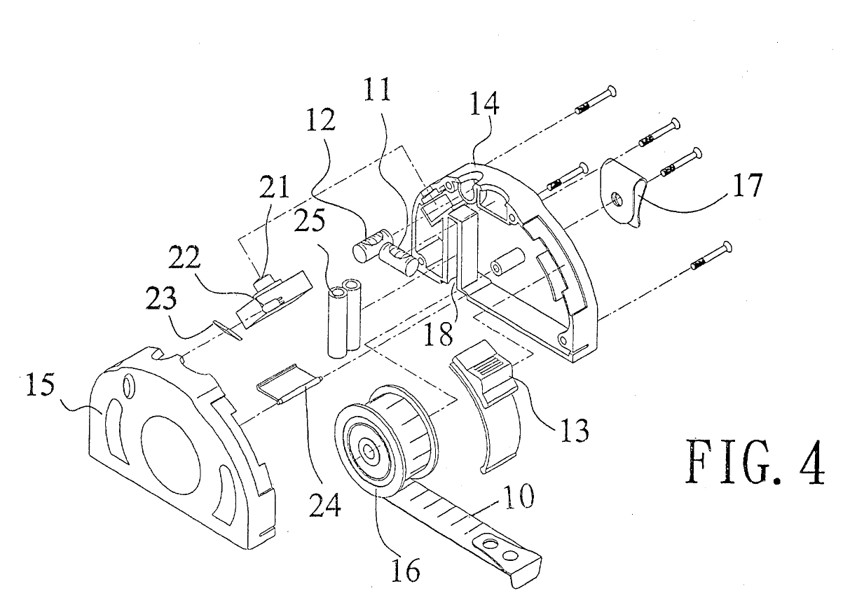

As shown in FIG. 4, the housing 1 is formed by a left housing 14 and a right housing 15 to join together. Inside the housing 1, there is a reel 3 for the measuring tape 10 to wind around; a stopper including a push button 13 is exposed outside the housing 1. On the housing, there are a plurality of spaces for holding the first horizon indicator 11, the second horizon indicator 12 and laser indicating mechanism. The laser indicating mechanism includes a switching button 21 with laser, generating circuit, a laser indicating bulb 22, and a refraction element 23. There is also a space for holding battery 18 as an electric power source for supplying electric power to the laser generating circuit. The battery 18 can be safely held inside the housing 1 by a battery cover 18 at the bottom of the housing 1. On one side surface of the housing 1, there is a hook 17 for the user to bring the tape rule with him.

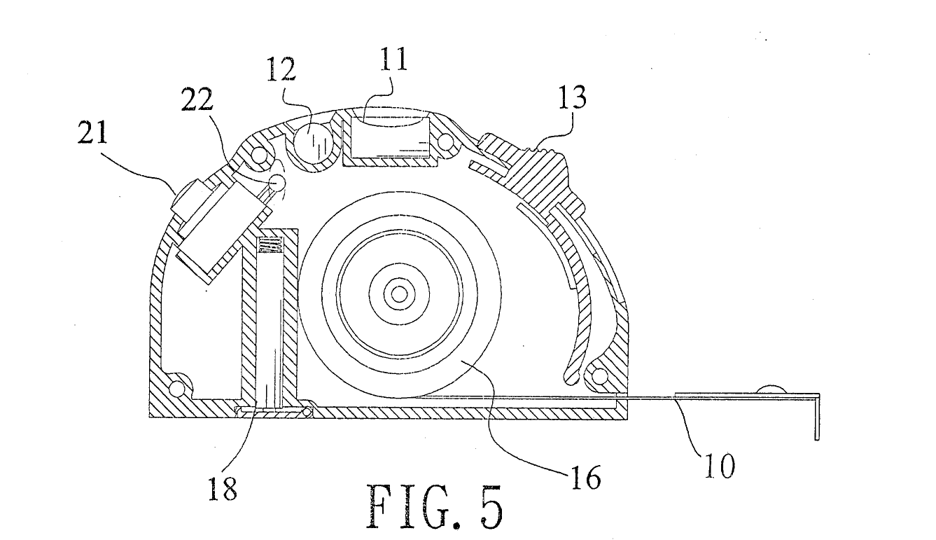

As shown in FIG. 5, it can be clearly seen that all of the tools including the first horizon indicator 11, the second horizon indicator 12, the push button 13, the measuring tape 10 with the reel 16, the switching button 21 with laser generating circuit, the laser indicating bulb 22 and the battery 18 etc. are properly arranged onto the housing 1.

In using the tape rule of the present invention, the measuring tape 10 can be retracted out of the housing to measure the length of an object or the distance between two objects. Since the first horizon indicator 11 and the second horizon indicator 12 are perpendicular to each other it then can determine whether a plane is on the horizontal plane both in x-direction and in y-direction.

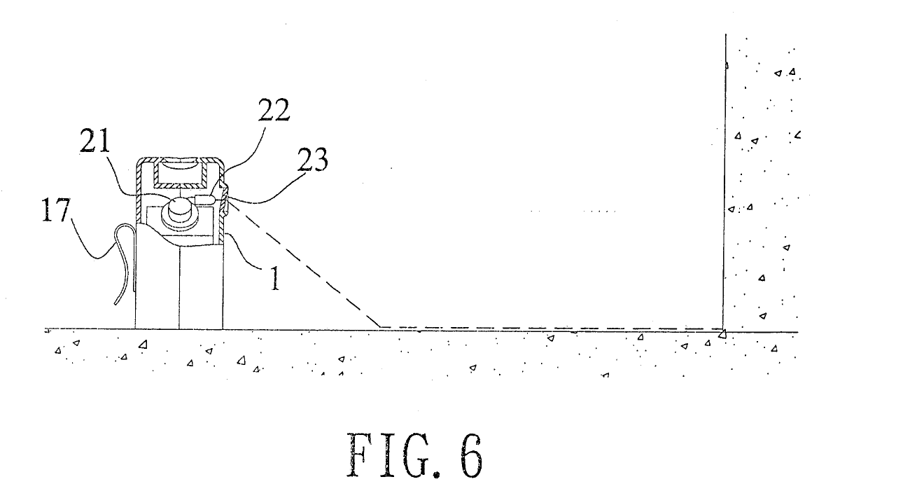

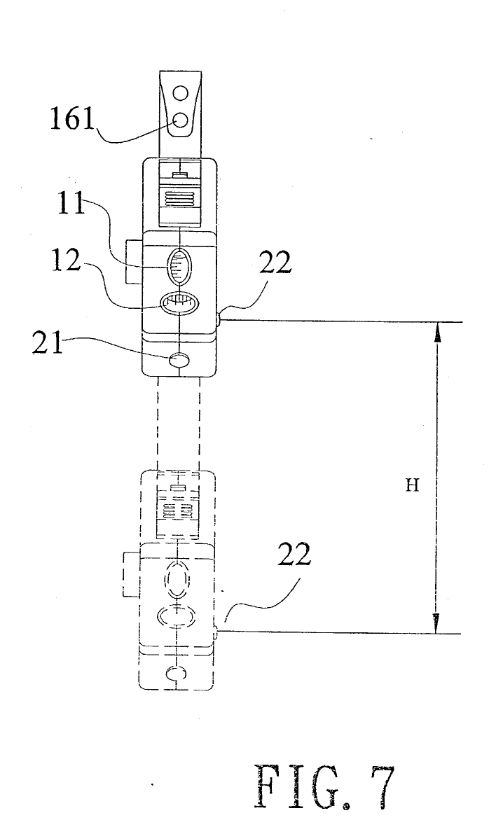

In addition, because there is a refraction element 23 in the laser indicating mechanism. Then as shown in FIG. 6, it would cause the laser beam emitted from the laser releasing bulb 22 to be refracted. Furthermore, as shown in FIG. 7, the laser beam emitted from the laser indicating bulb 22 also can be a straight laser beam, Such that the distance H between two points can be accurately indicated and measured.,

From the descriptions of the above, it can be clearly understood that the present invention provides functions that do not have been seen in prior arts. It is a new creation and a creation with practicalities.

Although the present invention has been described with a certain degree of particularity, the present disclosure has been made by way of example and changes in details of structure may be made without departing from the spirit thereof.

What is claimed is:

1. A tape rule having a laser indicating mechanism including:
a housing;
a retractable measuring to be held inside the housing;
a push button on the housing for stopping and releasing the measuring tape;
a horizon indicator for determining whether a surface is on a horizontal plane; and
a laser releasing bulb together with its switching button and laser generating circuit for indicating an object by releasing a beam of laser.

2. The tape rule having a laser indicating mechanism as claimed in claim 1, wherein a pair of horizon indicators are put onto the housing.

3. The tape rule having a laser indicating mechanism as claimed in claim 2, wherein the two horizon indicators are positioned perpendicular to each other such that they would determine whether the surface of an object is on a horizontal plane both in x-direction and in y-direction.

4. The tape rule having a laser indicating mechanism as claimed in claim 1, wherein said laser indicating mechanism includes a refraction element for causing the laser beam emitted from the laser releasing bulb to be refracted.

5. The tape rule having a laser indicating mechanism as claimed in claim 3, wherein said laser indicating mechanism includes a refraction element for causing the laser beam emitted from the laser releasing bulb to be refracted.

6. The tape rule having a laser indicating mechanism as claimed in claim 1, there is a set of batteries for supplying electric power to said laser generating circuit.

7. The tape rule having a laser indicating mechanism as claimed ill claim 3, there is a set of batteries for supplying electric power to said laser generating circuit.

8. The tape rule having a laser indicating mechanism as claimed in claim 4, there is a set of batteries for supplying electric power to said laser generating circuit.

9. The tape rule having a laser indicating mechanism as claimed in claim 5, there is a set of batteries for supplying electric power to said laser generating circuit.
